(19) United States
(12) Patent Application Publication
(10) Pub. No.: US 2007/0212227 A1
(43) Pub. Date: Sep. 13, 2007

(54) Pedestal for fan

(76) Inventor: Edwin T. Koehler, Cordova, TN (US)

Correspondence Address: BAKER, DONELSON, BEARMAN, CALDWELL & BERKOWITZ, SIX CONCOURSE PARKWAY, SUITE 3100, ATLANTA, GA, 30328, US

(21) Appl. No.: 11/374,786

(22) Filed: Mar. 13, 2006

(51) Int. Cl. F03D 11/00

(52) U.S. Cl. 416/246; 416/5

(57) ABSTRACT

A fan (10) in disclosed which includes a fan motor (11), a motor housing (12), a plurality of fan blades (13). The fan also includes an elongated pole (16) and a pedestal (17). The pedestal includes a main housing (18) and a lower portion (19). The main housing has a shroud (21) and a hollow spindle (22). The shroud and spindle have a coextensive central channel (23) configured to receive the elongated pole. The lower portion has a plate-like skirt (26) and a centrally positioned mounting post (28). The mounting post includes a narrower top end (29) configured to be telescopically received within the bottom end of the pole. The diameter of the skirt is much greater than the diameter of the accompanying shroud to restrict tipping of the fan due to an external force place upon it.

### TECHNICAL FIELD

This invention relates to pedestals, and specifically to pedestals for use with a fan.

### BACKGROUND OF THE INVENTION

Traditionally, ceiling fans have been installed by a laborious, time consuming and often cumbersome practice. The conventional ceiling fan includes a ceiling plate which is secured to an electric outlet box by passing the lead wires of the outlet box through a central circular opening in the ceiling plate. Mounting screws are passed through two elongated openings in the ceiling plate to threadingly engage with two threaded holes diagonally separated from each other on the periphery of the outlet box. Alternatively, wood screws are passed through the ceiling plate and the outlet box and into a wood stud which supports the outlet box. In either event, the screws are tightened until the ceiling plate is securely mounted on the outlet box. The typical ceiling plate includes a hanging hook.

When a typical ceiling fan assembly is mounted to the ceiling plate, the motor, fan blades and an optional light assembly are secured to a canopy by a down rod or hanger rod. The down rod passes through a central opening in the canopy with a ball mount located at an end of the down rod engaged by a periphery of the opening of the canopy.

This mounting of a ceiling fan is limited by the ceiling itself and the location of electrical wires. It would be convenient to be able to move a ceiling fan to any location within a space, even those spaces without a ceiling such as upon a lawn or outdoor deck, to provide an airflow. To solve this problem, fans have been designed to be mounted to a pole, as shown in U.S. Pat. Nos. 6,017,188 and 6,821,089. These fans typically utilize a table, through which the pole extends, to provide stability, i.e., to prevent the pole from tipping over. However, it would be desirous to design a pole fan without the need of an ancillary table to provide stability.

Accordingly, it is seen that a need has long existed for a pole fan that could be more easily and quickly relocated and utilized without ancillary structure. It thus is to the provision of such that the present invention is primarily directed.

### SUMMARY OF THE PRESENT INVENTION

In a preferred form of the invention, a fan comprises an electric motor, a motor housing, a plurality of blades coupled to the motor, a pole having a top end and a bottom end opposite the top end. The top end being coupled to the motor housing. The fan also has a pedestal coupled to the pole bottom end, the pedestal having a main housing portion and a lower portion coupled to the housing portion. The housing portion has a select diameter and the skirt lower portion has a select diameter greater than the housing portion select diameter.

### BRIEF DESCRIPTION OF THE DRAWINGS

FIG. 1 is a perspective view of a fan in a preferred form of the invention.

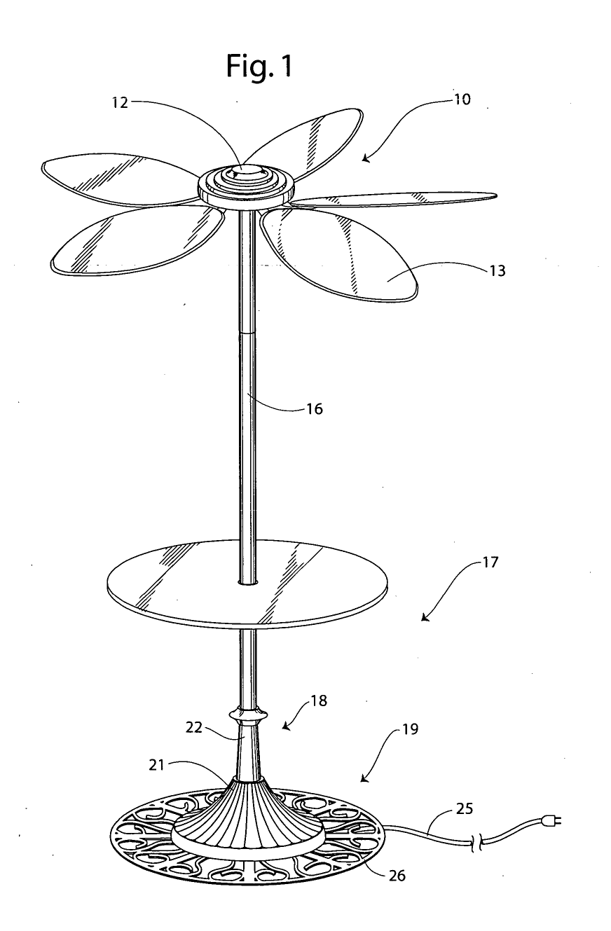

FIG. 2 is a partial cross-sectional, perspective view of the pedestal of the fan of FIG. 1.

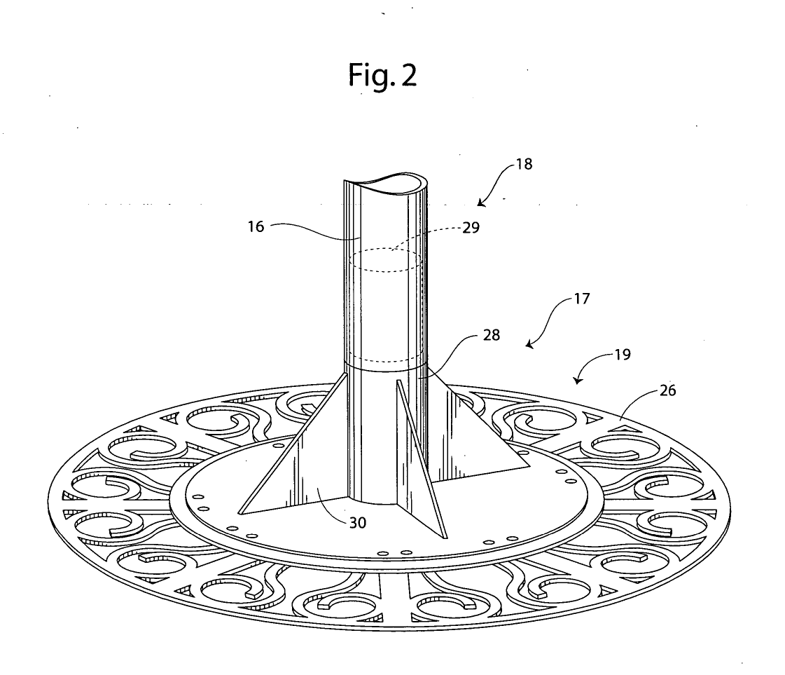

FIG. 3 is a cross-sectional side view of the fan of FIG. 1.

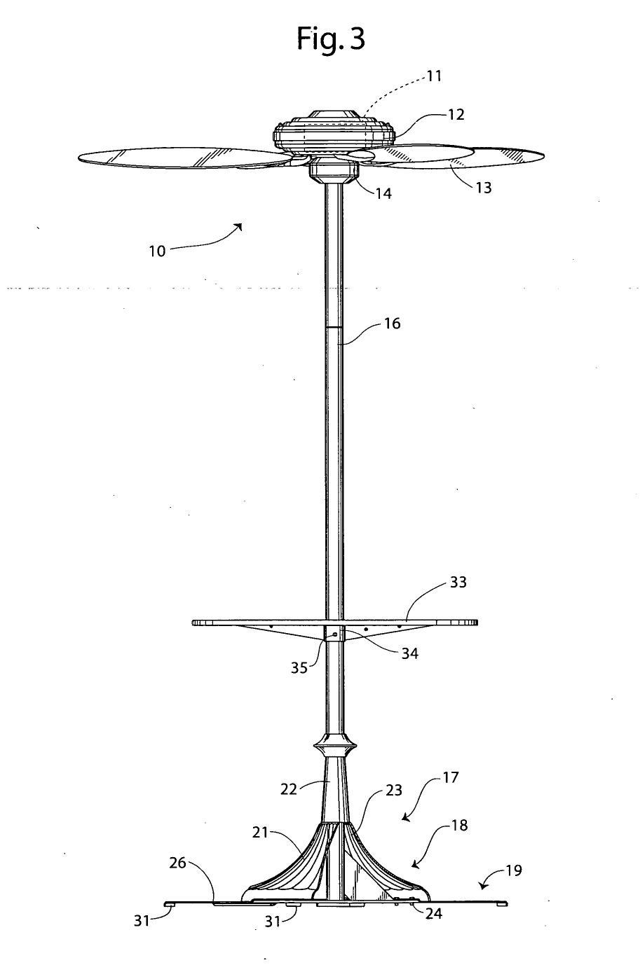

### DETAILED DESCRIPTION OF THE PREFERRED EMBODIMENTS

With reference next to the drawings, there is shown a fan 10 in a preferred form of the invention. The fan 10 includes a fan motor 11, a motor housing 12, a plurality of fan blades 13 coupled to the motor, and a switch housing 14 to which an optional light kit may be mounted. It should be noted that as used herein the switch housing may be included as a portion of the motor housing.

The fan 10 also includes a vertically extending, elongated, hollow pole 16 and a pedestal 17 coupled to the bottom end of the pole 16. The pedestal 17 includes an upper portion or main housing 18 and a lower portion 19 at least a portion of which extends outwardly from the main housing 18. The main housing 18 has an inverted, generally funnel-shaped, shroud 21 and a hollow spindle 22 extending upwardly from the shroud 21. The shroud 21 and spindle 22 have a coextensive central channel 23 configured to receive the elongated pole 16. The lower portion 19 is mounted to the main housing 18 through a series of bolts 24 extending therebetween. An electrical cord 25, utilized to power the motor, extends through the pedestal 17 and centrally through the elongated pole 16 to the motor 11.

The lower portion 19 has a plate-like skirt 26 and a centrally positioned mounting post 28 extending upwardly from the skirt 26. The mounting post 28 includes a narrower top end 29 configured to be telescopically received within the bottom end of the pole 16. A plurality of buttresses or braces 30 extend between the skirt 26 and the mounting post 28. The lower portion 19 may also include a plurality of feet 31 which elevate the skirt from an underlying support surface to enhance the stability by avoiding inconsistencies in the support surface.

It should be noted that the diameter of the skirt 26 is much greater than the diameter of the accompanying shroud 21. This enables the pedestal 17 to securely hold the pole 16 while providing a large “footprint” or foundation area for stability, i.e., the peripheral edge of the skirt 26 is set a great distance from the center to restrict tipping of the fan due to an external force place upon it.

Optionally, the fan 10 may includes a tabletop 33 coupled to the exterior of the pole 16 through a collar 34. The tabletop 33 may be moved along the length of the pole and then fixed in a desired location through set screws 35 or the like.

It should be understood that while the preferred embodiment shows a pedestal having a generally circular configuration, the invention is not limited to such. For example, the pedestal may be configured with a square shape, or other polygonal shape. It should also be understood that as an alternative to the series of specially mounted feet, the lower portion may include one annular foot having a passage therethrough through which the electric cord extends. Also, it should be understood that the mounting post 28 may be configured with a central channel configured to receive the pole, rather than the reverse configuration shown in the preferred embodiment.

It thus is seen that a fan is now provided that overcomes problems associated with the prior art. It should be understood that many modifications may be made to the specific preferred embodiment described herein without departure from the spirit and scope of the invention as described by the following claims.

1. A fan comprising,
an electric motor;
a motor housing;
a plurality of blades coupled to said motor;
a pole having a top end and a bottom end opposite said top end, said top end being coupled to said motor housing, and
a pedestal coupled to said pole bottom end, said pedestal having main housing portion and a lower portion coupled to said housing portion, said housing portion having a select diameter and said lower portion having a select diameter greater than said housing portion select diameter.

2. The fan of claim 1 wherein said main housing portion has a central channel configured to receive a portion of said pole.

3. The fan of claim 1 further comprising at least one foot extending from the underside of said lower portion.

4. The fan of claim 1 wherein said pedestal housing portion includes a shroud and a spindle extending upwardly from said shroud.

5. The fan of claim 1 wherein said lower portion including a skirt and mounting post configured to be coupled with said pole and extending from said skirt.

6. A fan comprising,
a fan portion having an electric motor, a motor housing, and a plurality of blades coupled to said motor;
a pole having a first end coupled to said fan portion; and
a pedestal coupled to a second end of said pole opposite said first end, said pedestal having main housing portion and a lower portion coupled to said housing portion, said housing portion having a select diameter and said lower portion having a select diameter greater than said housing portion select diameter.

7. The fan of claim 6 wherein said main housing portion has a central channel configured to receive a portion of said pole.

8. The fan of claim 6 further comprising at least one foot extending from the underside of said lower portion.

9. The fan of claim 6 wherein said pedestal housing portion includes a shroud and a spindle extending upwardly from said shroud.

10. The fan of claim 6 wherein said lower portion including a skirt and mounting post configured to be coupled with said pole and extending from said skirt.

11. A fan comprising,
a fan portion having an electric motor, a motor housing, and a plurality of blades coupled to said motor;
a pole having a first end coupled to said fan portion; and
a pedestal coupled to a second end of said pole opposite said first end, said pedestal having shroud portion and a skirt portion coupled to said shroud portion, said skirt portion having a pole mounting post having an upper end configured to mate with said second end of said pole.

12. The fan of claim 11 wherein said shroud portion has a select diameter and said skirt portion has a select diameter greater than said shroud portion select diameter.

13. The fan of claim 11 wherein said shroud portion has a central channel configured to receive a portion of said pole.

14. The fan of claim 11 further comprising at least one foot extending from the underside of said skirt portion.
